(19) United States
(12) Patent Application Publication
(10) Pub. No.: US 2026/0309205 A1
(43) Pub. Date: Oct. 8, 2026

(54) Telescopic Tube Assembly with Idle Stroke and Integrated Damper

(71) Applicants: Günther Zimmer, Rheinau (DE); Martin Zimmer, Rheinau (DE)

(72) Inventors: Günther Zimmer, Rheinau (DE); Martin Zimmer, Rheinau (DE)

(21) Appl. No.: 19/635,944

(22) Filed: Apr. 1, 2026

(30) Foreign Application Priority Data
Apr. 4, 2025 (DE) 10 2025 001 163.6

(51) Int. Cl. F16F 13/00; E05F 3/02; E05F 3/10

(52) U.S. Cl. CPC F16F 13/00; E05F 3/02; E05F 3/108; E05Y 2201/224; E05Y 2201/266; E05Y 2900/30; F16F 2222/12; F16F 2228/066; F16F 2230/007; F16F 2232/08

(57) ABSTRACT

A telescopic tube assembly includes an outer tube and a base tube. The base tube is displaceable in the outer tube from a start position in a working stroke direction into an end position and back. A damper piston connected to a piston rod is displaceably mounted in the base tube. The piston rod projects into an idle stroke space delimited by a stop wall. The idle stroke space is arranged in the outer tube or the base tube that does not accommodate the damper piston. In the start position, the piston rod is spaced apart from the stop wall. In the end position, the piston rod bears against the stop wall. During movement of the outer tube relative to the base tube in the working stroke direction the piston rod strikes against the stop wall. During further movement the piston rod displaces the damper piston, thereby dampening the movement.

### CROSS-REFERENCE TO RELATED APPLICATION

This application claims the benefit of German Patent Application DE 10 2025 001 163.6, filed on Apr. 4, 2025, the entire contents of which is incorporated by reference.

### TECHNICAL FIELD

The present disclosure relates to telescopic tube assemblies with integrated damping systems for controlled relative movement of structural components, suitable for use in appliances such as grills and chest freezers.

### BACKGROUND

A telescopic tube assembly is known from U.S. Pat. No. 8,251,376B2. The damper has a piston rod fastened in an outer tube.

### SUMMARY

A telescopic tube assembly has an outer tube and a base tube which is guided in the outer tube so as to be displaceable in a longitudinal direction from a start position in a working stroke direction into an end position and back, wherein a damper piston connected to a piston rod is displaceably mounted in the base tube or in the outer tube.

The present disclosure is based on the problem of developing a robust and low-fault telescopic tube assembly. This problem is solved in that the piston rod projects into an idle stroke space delimited by at least one stop wall, wherein the idle stroke space is arranged in the outer tube or the base tube that does not accommodate the damper piston. In the start position, the piston rod is spaced apart from the stop wall. In the end position, the piston rod bears against the stop wall. During a displacement movement of the outer tube and the base tube relative to one another from the start position in the working stroke direction, the piston rod strikes against the stop wall. Upon continuation of the said displacement movement directed in the working stroke direction, the piston rod displaces the damper piston, which damps this displacement movement, relative to the base tube or the outer tube accommodating the damper piston.

The utilized total stroke of the telescopic tube assembly is composed of an idle stroke and a damping stroke. During displacement of the base tube and the outer tube relative to one another in the working stroke direction, the idle stroke is first consumed before damping begins. In the telescopic tube assembly, the piston is displaceably mounted in the base tube in a damping medium, for example a hydraulic fluid or a pneumatic fluid. In the start position of the telescopic tube assembly, the piston rod connected to the piston projects into the idle stroke space. This idle stroke space is formed in the outer tube. The piston rod is thereby not subjected to external longitudinal forces or transverse forces, nor to internal forces. As a result, even during operation in a harsh environment, the integrated damper is protected against damage.

Further details of the invention are apparent from the dependent claims and from the following description of schematically illustrated embodiments.

### BRIEF DESCRIPTION OF THE DRAWINGS

FIG. 1: Device in the operating position;

FIG. 2: Device with the device lid pivoted open by 15 degrees;

FIG. 3: Device with the device lid pivoted open by 45 degrees;

FIG. 4: Device in the open position;

FIG. 5: Telescopic tube assembly in the end position;

FIG. 6: Longitudinal section of the telescopic tube assembly of FIG. 5 in the start position;

FIG. 7: Longitudinal section of the telescopic tube assembly of FIG. 5;

FIG. 8: Connection insert;

FIG. 9: Variant of a telescopic tube assembly in the start position;

FIG. 10: Variant of FIG. 9 in the end position;

FIG. 11: Detail of the outer tube of FIGS. 9 and 10;

FIG. 12: Device with telescopic tube assembly in the end position;

FIG. 13: Device of FIG. 12 with telescopic tube assembly in the start position.

### DETAILED DESCRIPTION

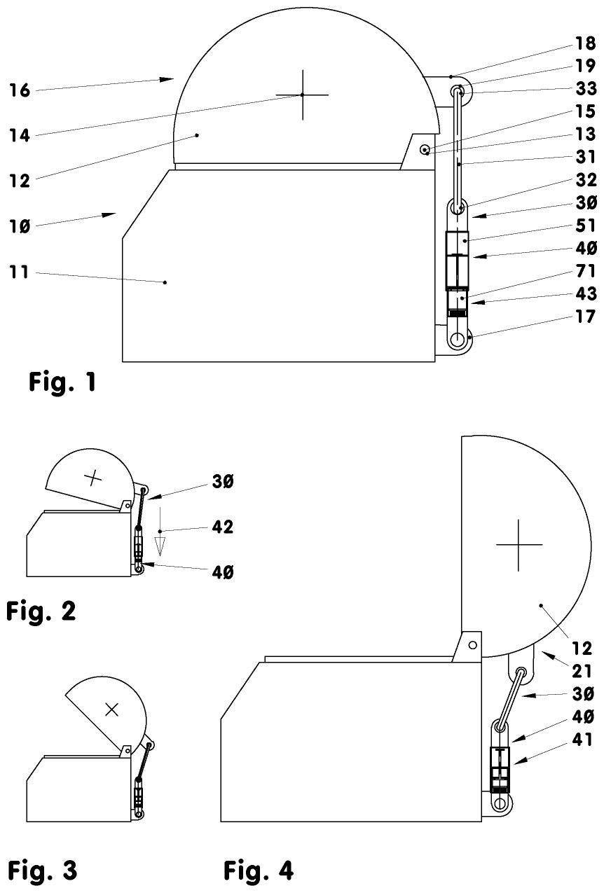

FIGS. 1-4 show a device (10) having a device lower part (11) and a device lid (12). The device (10) may be, for example, a stationary or a movable grill, a chest freezer, etc. The device lid (12) is pivotably mounted on the device lower part (11) by, for example, two pivot joints (13). The pivot axis (15) of the pivot joints (13) is oriented in a horizontal direction.

FIG. 1 shows the device (10) in an operating position (16). The device lid (12) is in a closed position. For example, it bears on the device lower part (11). In this exemplary embodiment, the device lid (12) is configured in the form of a hood. The device lid (12) has a center of mass (14) which, in the illustration of FIG. 1, is located in space above the pivot axis (15) and offset relative to the pivot axis (15). In this illustration, the vertically oriented center-of-mass line intersects the device lower part (11) centrally.

A first mounting point (17) on the device lower part side is arranged on the device lower part (11), and a second mounting point (18) on the device lid side is arranged on the device lid (12). The mounting point (17) on the device lower part side and the mounting point (18) on the device lid side lie in a common vertical plane. This plane is oriented normal to the pivot axis (15). The two mounting points (17, 18) retain a damper assembly (30). In the exemplary embodiment, this damper assembly (30) has a telescopic tube assembly (40) and a tension cable (31). The telescopic tube assembly (40) has an outer tube (51), in which a base tube (71) is guided so as to be linearly displaceable. The telescopic tube assembly (40) is arranged, for example, on the device lower part (11) in a vertical direction. In the illustrations of FIGS. 1-4, the base tube (71) points downward. The base tube (71) is, for example, rigidly retained at the mounting point (17) on the device lower part side. The outer tube (51) has, in this exemplary embodiment, a top-side base (52). The tension cable (31) is fastened to this base (52) in this exemplary embodiment. The tension cable (31) is, for example, a multi-strand wire cable which carries, at its ends, in each case a thimble (32, 33). One of the thimbles (32) passes through a cable eye (53) arranged on the base (52). The other thimble (33) is retained in a second cable eye (19). This second cable eye (19) is part of the mounting point (18) on the device lid side.

The damper assembly (30) may be configured without a tension cable (31). In this case, pivot joints may be arranged on the outer tube (51) and on the base tube (71). For example, one of these pivot joints connects the base tube (71) to the device lower part (11). The other pivot joint then connects the outer tube (51) to the device lid (12). In this case as well, the damper assembly (30) is arranged in a vertical plane which intersects the device (10).

In the operating position (16) shown in FIG. 1, the damper assembly (30) has its maximum length. The telescopic tube assembly (40) is extended. It is in an end position (43). The tension cable (31) is under tension.

For manual opening of the device lid (12), the device lid (12) is pivoted relative to the device lower part (11) about the pivot axis (15). FIG. 2 shows an unstable intermediate position in which the housing lid (12), with reference to the illustration of FIG. 1, is pivoted open, for example, by an angle of 15 degrees. In the illustration of FIG. 2, the telescopic tube assembly (40) is shortened. In this case, the base tube (71) is retracted further into the outer tube (51) compared to the illustration of FIG. 1. This retraction takes place, for example, under gravity. The retraction movement may also be assisted by a return spring. The length of the tension cable (31) remains unchanged.

In the illustration of FIG. 3, the device lid (12) is pivoted open from the operating position (16) by an angle of 45 degrees. In this unstable intermediate position, the telescopic tube assembly (40) is further shortened. The base tube (71) is retracted further into the outer tube (51). The length of the tension cable (31) remains unchanged.

In FIG. 4, the device (10) is shown with the device lid (12) open. In this open position (21), the device lid (12) is pivoted open relative to the operating position (16) by an angle of, for example, 90 degrees. During pivoting open, a center-of-mass line applied at the center of mass (14) of the device lid (12) has passed through the pivot axis (15). The maximum pivot angle of the device lid (12) relative to the device lower part (11) may be, for example, up to 115 degrees. The maximum pivot angle of the device lid (12) may be limited by a stop projecting from the device lower part (11), a hinge stop, etc.

In the open position (21), the device lid (12) is in a stable position relative to the device lower part (11). The center-of-mass line of the device lid (12) lies outside the device lower part (11) and outside the pivot axis (15). The base tube (71) is retracted further into the outer tube (51). The telescopic tube assembly (40) has reached a start position (41). The length of the tension cable (31) remains unchanged.

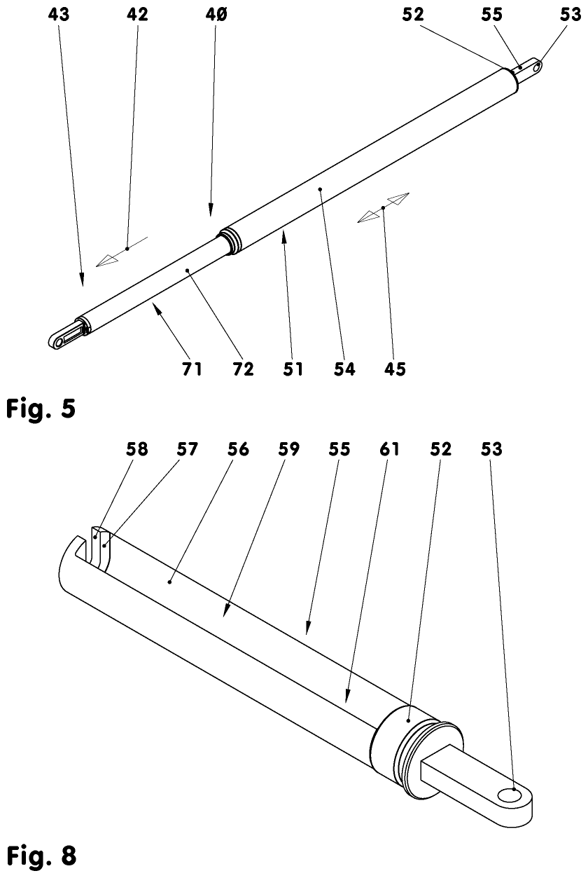

FIGS. 5-8 show a telescopic tube assembly (40) and some of its individual components. The total length of the telescopic tube assembly (40) in the retracted state is, for example, 255 millimeters. In the extended state, the total length is, for example, 40% greater than this length. The telescopic tube assembly (40) has an outer tube (51) with an outer diameter of, for example, 14 millimeters. The length of the outer tube (51) is, for example, 58% of the length of the extended telescopic tube assembly (40). The outer tube (51) has an outer tube section (54). This has, for example, a constant wall thickness of 0.5 millimeters and a circular annular cross section that is constant over its length. The outer tube (51) is closed at its free end by means of a connection insert (55). In this connection insert (55), the base (52) and the cable eye (53) are formed.

The connection insert (55), see FIG. 8, has a receiving cup (56) which is arranged in the outer tube (51). The receiving cup (56) is delimited, in the direction of the cable eye (53), by the base (52) and, in the direction of the base tube (71), by a stop wall (57). The base (52) is configured, for example, in the shape of a circular disk. The stop wall (57) has a transverse slot (58) of constant width, which adjoins an assembly opening (59). The assembly opening (59) has, in a plan view, a rectangular cross section. The length of the assembly opening (59) in a longitudinal direction (45) of the telescopic tube assembly (40) corresponds to the distance between the stop wall (57) and the base (52). The width of the assembly opening (59) corresponds, for example, to the inner diameter of the receiving cup (56). The space bounded by the receiving cup (56) and the outer tube (51) is referred to below as the idle stroke space (61). The length of this idle stroke space (61) is the distance between the stop wall (57) and the base (52). For example, this length is between 20% and 35% of the length of the telescopic tube assembly (40) in the retracted state. In the exemplary embodiment, the length of the idle stroke space (61) corresponds to 29% of the length of the telescopic tube assembly (40) in the retracted state.

At its end facing away from the base (52), the outer tube (51) carries an annular sliding element (62). In the exemplary embodiment, this has a radial clearance of 0.4 millimeters relative to the base tube (71). The gap seal (64) thus formed seals the base tube (71) relative to the outer tube (51). Sealing by means of a sealing lip is also conceivable.

The length of the base tube (71) is, in the exemplary embodiment, 60% of the length of the outer tube (51). The base tube (71) has a base tube section (72) and a guide section (73). The outer diameter in the base tube section (72) is, for example, 71% of the diameter of the outer tube (51). The base tube section (72) has a circular cross section that is constant over its length. The wall thickness of the base tube section (72) corresponds to the wall thickness of the outer tube section (54).

At its projecting end, the base tube (71) has a compensation insert (74). A closure plug (75) is seated in the compensation insert (74). This closure plug (75) is, for example, connected to the mounting point (17) on the device lower part side. In the illustrated exemplary embodiment, the closure plug (75) has, for this purpose, a through bore (76).

The compensation insert (74) has an insert tube (77), which is seated in the base tube section (72) in a sealed manner. A compensation piston (78) is displaceably mounted in the insert tube (77). The compensation piston (78) bears against the inner wall of the insert tube (77) by means of an annular compensation piston seal (79). A compensation spring (81) supports the compensation piston (78) on the closure plug (75).

At the end of the base tube (71) facing away from the compensation insert (74), a cylinder head insert (82) is seated. The cylinder head insert (82) has an outer surface (83) configured as a sliding surface. In the assembled telescopic tube assembly (40), during a relative movement of the base tube (71) and the outer tube (51) with respect to one another, the outer surface (83) slides along the inner wall of the outer tube (51). It thereby forms the guide section (73) of the base tube (71).

The cylinder head insert (82) has a longitudinal passage (84), in which a sealing ring (85) is seated. The sealing ring (85) surrounds a piston rod (86) and is fixed by means of a retaining ring (87) fixed in the cylinder head insert (82). The piston rod (86) is connected to a damper piston (88) which is displaceably mounted in the base tube (71). In the exemplary embodiment, the piston rod (86) has a diameter of three millimeters. A piston rod head (96) of the piston rod (86) projects into the idle stroke space (61). This piston rod head (96) has, for example, an annular disk (89). The thickness of the annular disk (89) in the longitudinal direction (45) corresponds, for example, to the diameter of the piston rod (86).

The damper piston (88) has throttle bores (91) oriented in the longitudinal direction (45). A valve disk (92) of the damper piston (88), which is displaceable on the piston rod (86), can vary the cross sections of the throttle bores (91) depending on the stroke direction. In the exemplary embodiment, the valve disk (92) is arranged on the side of the damper piston (88) facing the cylinder head insert (82). The interior space (93) of the base tube (71) is filled with, for example, a hydraulic fluid. The use of a gas in the interior space (93) of the base tube (71) is also conceivable.

In the base tube (71), the damper piston (88) separates a displacement space (94) from a compensation space (95). The maximum stroke of the damper piston (88) is the maximum usable displacement path of the damper piston (88) between a retracted position and an extended position of the piston rod (86).

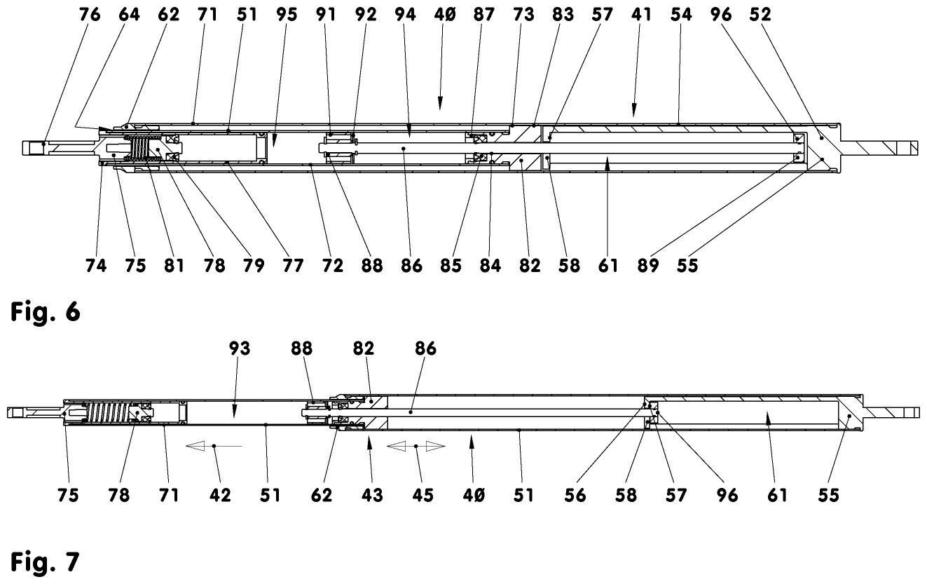

With the device lid (12) open, see FIG. 4, the telescopic tube assembly (40) is retracted. For example, in this start position (41), the base tube (71) and the outer tube (51) are arranged relative to one another as shown in FIG. 6. The base tube (71) is retracted into the outer tube (51). In this illustration, the base tube (71) bears, with the cylinder head insert (82), against the connection insert (55) of the outer tube (51). The piston rod (86) with the annular disk (89) has a small distance from the base (52). In the base tube (71), the damper piston (88) is located in a central position in the longitudinal direction (45).

During closing of the device lid (12), see FIGS. 3 and 2, the device lid (12) pulls the outer tube (51) upward relative to the base tube (71) by the tension cable (31). In this process, the base tube (71) is extended relative to the outer tube (51) in the working stroke direction (42). The length of the telescopic tube assembly (40) is increased. During this extension, the damper piston (88) initially remains stationary relative to the base tube (71). For example, no fluid is displaced between the displacement space (94) and the compensation space (95).

During extension of the outer tube (51) relative to the base tube (71), the connection insert (55) with the receiving cup (56) is moved along. The distance of the receiving cup (56) from the cylinder head insert (82) is increased. The idle stroke space (61) is displaced relative to the stationary piston rod (86), such that the stop wall (57) approaches the piston rod (86). The tension cable (31) and the device lid (12) experience no resistance during this idle stroke of the telescopic tube assembly (40). The movement of the base tube (71) and the outer tube (51) relative to one another is not influenced by the damper piston (88).

Upon further closing of the device lid (12), the idle stroke of the telescopic tube assembly (40) is terminated once the stop wall (57) strikes against the piston rod (86). Up to this point, the position of the damper piston (88) relative to the base tube (71) remains unchanged. The center of mass (14) of the device lid (12) now lies above the device lower part (11).

If the device lid (12) is closed further in the direction of the operating position (16) shown in FIG. 1, the tension cable (31) continues to pull the outer tube (51) upward. By means of the stop wall (57), the outer tube (51) pulls the piston rod (86) upward relative to the, for example, fixed base tube (71). The base tube (71) is extended further in the working stroke direction (42) relative to the outer tube (51). During the displacement movement in the working stroke direction (42), the length of the telescopic tube assembly (40) is increased. The piston rod (86) carries the damper piston (88) along relative to the base tube (71). In this process, the valve disk (92) bears against the outlets of the throttle bores (91). Oil from the displacement space (94) is throttled into the compensation space (95). The further extension movement of the piston rod (86)—and thus the closing movement of the device lid (12)—is decelerated. Even if the device lid (12) is now let go, it lowers only slowly onto the device lower part (11). The telescopic tube assembly (40) is extended further.

FIGS. 1 and 7 show the extended telescopic tube assembly (40) in the end position (43). The piston rod (86) bears against the stop wall (57). The damper piston (88) bears, for example, against the cylinder head insert (82) or has a small distance from it. In this exemplary embodiment, the utilized idle stroke amounts to 70% of the total stroke of the telescopic tube assembly (40). The utilized damping stroke amounts to 30% of the total stroke. Thus, the utilized idle stroke is more than twice as large as the utilized damping stroke.

Upon renewed opening of the device lid (12), the tension cable (31) is relieved. The outer tube (51) moves downward under gravity. In this process, the piston rod (86), which is free of force, initially remains largely stationary. The base (52) approaches the piston rod (86). As soon as the idle stroke is consumed, the base (52), during further lowering of the outer tube (51), pushes the piston rod (86) downward. The piston rod (86) displaces the damper piston (88) downward counter to the damping direction. The fluid flowing from the compensation space (95) into the displacement space (94) lifts the valve disk (92), such that no or only slight deceleration occurs during this movement. The telescopic tube assembly (40) is retracted until it has reached, for example, the retracted length of the start position (41) shown in FIG. 6.

A return spring may be used to assist the return movement. This is, for example, configured as a compression spring and is arranged on the piston rod (86) between the damper piston (88) and the cylinder head insert (82).

The total stroke, the utilized idle stroke, and the utilized damping stroke may be adjustable. For this purpose, for example, the length of the piston rod (86) may be adjustable. It is also conceivable, for example, to use compensation plates on the stop wall (57) and/or on the base (52), which limit the utilized stroke. Adjustable stroke stops, for example for setting the total stroke, are also conceivable. A second, additional damper may also be arranged in the idle stroke space (61). In this case, for example, a cylinder base of the second damper forms the stop wall (57).

The structure and the arrangement of the telescopic tube assembly (40) prevent the ingress of dirt and enable effective cleaning. The piston rod is not subjected to transverse forces in any operating state.

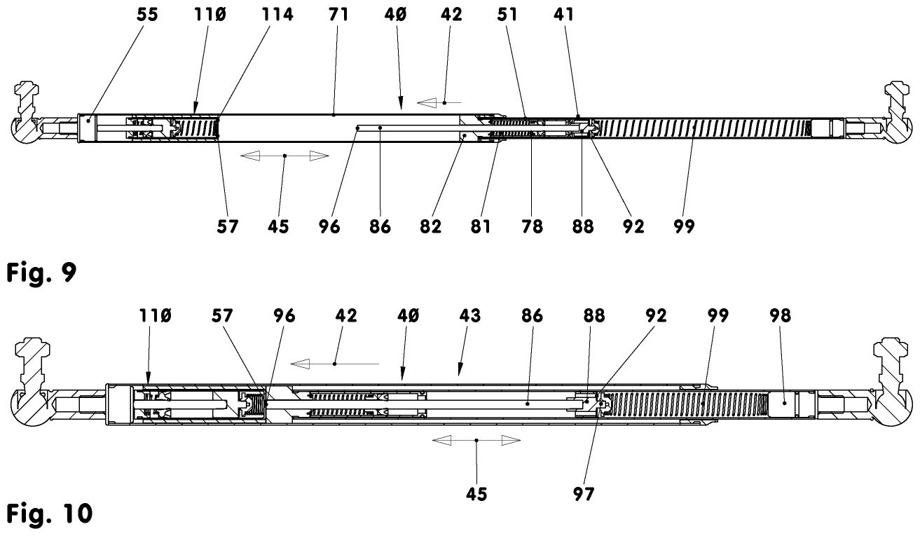

FIGS. 9-11 show a telescopic tube assembly (40) in which, during a movement of the outer tube (51) and the base tube (71) relative to one another in the working stroke direction (42), the length of the telescopic tube assembly (40) is reduced. The base tube (71) and the outer tube (51) have, for example, in each case the same diameters as the corresponding components of the first exemplary embodiment. The length of the telescopic tube assembly (40) of this exemplary embodiment in the extended state is, for example, 24% greater than the length of the telescopic tube assembly (40) shown in FIGS. 1 and 7. The total stroke of the telescopic tube assembly (40) shown in FIGS. 9-11 is 30% greater than the stroke of the telescopic tube assembly (40) shown in the first exemplary embodiment.

A damper piston (88) is arranged in the base tube (71). A piston rod (86) is fastened to the damper piston (88). A spring-loaded compensation piston (78) is arranged in a compensation space (95) between a cylinder head insert (82) and the damper piston (88). The piston rod (86) passes through the compensation space (95) and the cylinder head insert (82) and projects into the idle stroke space (61). The piston rod head (96) is configured as a stop surface. The stroke of the damper piston (88) amounts, for example, to 38% of the total stroke of the telescopic tube assembly (40).

The damper piston (88) has throttle bores (91) oriented in the longitudinal direction (45) and a valve disk (92) that is displaceable in the longitudinal direction. The valve disk (92) is arranged in the displacement space (94). The damper piston (88) functions analogously to the damper piston (88) described in connection with the first exemplary embodiment.

A return spring (99) is supported on a piston pin (97) and on a base tube base (98). This return spring (99) is configured as a compression spring and loads the damper piston (88) in the direction of the outer tube (51).

The telescopic tube assembly (40) of this exemplary embodiment has an auxiliary damper (110). This is arranged, for example, in a damper sleeve (63), which is displaceably mounted in the outer tube (51). The auxiliary damper (110) is configured as a cylinder-piston unit. It has an auxiliary damping cylinder (111), in which an auxiliary damping piston (112) with an auxiliary piston rod (113) fastened to the auxiliary damping piston (112) is mounted. The auxiliary damping cylinder (111) has a closed cylinder base (114). This cylinder base (114) faces in the direction of the base tube (71). An auxiliary cylinder head (115) is oriented in the direction of the connection insert (55) of the outer tube (51). The auxiliary piston rod (113) of the auxiliary damper (110) passes through the auxiliary cylinder head (115). In the illustrations of FIGS. 9-11, the auxiliary piston rod (113) bears against the connection insert (55).

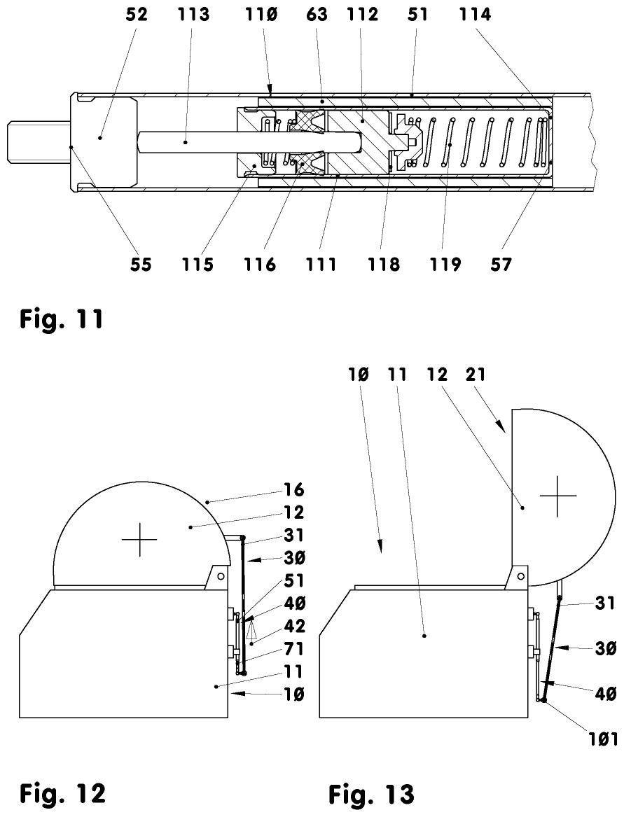

The auxiliary damper (110) is configured, in the exemplary embodiment, as a hydraulic damper. It is also conceivable to use a gas damper as the auxiliary damper (110). The auxiliary damper (110), shown enlarged in FIG. 11, has a spring-loaded auxiliary compensation sealing element (116). The auxiliary damping piston (112) has a valve disk (118), which is arranged on the side facing away from the auxiliary piston rod (113). An auxiliary return spring (119) is arranged between the auxiliary damping piston (112) and the cylinder base (114). The stroke of the auxiliary damper (110) amounts, in the exemplary embodiment, to 30% of the stroke of the damper piston (88) arranged in the base tube (71).

FIGS. 12 and 13 show an application example of the telescopic tube assembly (40) shown in FIGS. 9-11. The telescopic tube assembly (40) is, for example, part of a damper assembly (30) which delays the closing of a device lid (12). The device lower part (11), the device lid (12), and the pivot joints (13) are constructed, for example, as described in connection with FIGS. 1-4. The telescopic tube assembly (40) is, for example, fastened to the device lower part (11) in a dual mounting point (17) on the device lower part side. The mounting point (17) on the device lower part side holds, for example, the outer tube (51) in a fixed position, from which the base tube (71) projects downward. The free end of the base tube (71) carries a cable eye (101). This cable eye (101) is connected by means of a tension cable (31) to a cable eye (19) arranged on the device lid (12). At least when the device lid (12) is closed, the tension cable (31) is under tension. In this operating position (16) of the device lid (12), the telescopic tube assembly (40) is in its end position (43). It has its shortest length, see FIGS. 9 and 12.

During opening of the device lid (12) from the operating position (16), the tension cable (31) is relieved. The base tube (71) is displaced downward with almost no resistance. The piston rod (86) and the auxiliary piston rod (113) are relieved. At the same time, the return spring (99) and the auxiliary return spring (119) are relieved. The piston rod (86) is extended relative to the base tube (71). The auxiliary piston rod (113) is extended relative to the auxiliary damping cylinder (111). In this process, the damper sleeve (63), together with the auxiliary damper (110), is displaced in the outer tube (51) in the direction of the base tube (71). In the open position (21) of the device lid (12) shown in FIG. 13, the telescopic tube assembly (40) has, for example, reached the maximum length shown in FIG. 9. It is now in the start position (41).

During closing of the device lid (12) from the open position (21), the tension cable (31) is carried along by the cable eye (19) of the device lid (12). The tension cable (31) pulls the base tube (71) upward relative to the fixed outer tube (51). The base tube (71) is retracted into the outer tube (51) in the working stroke direction (42) of this exemplary embodiment. The retraction of the base tube (71) initially takes place largely without resistance until the piston rod (86) strikes against the cylinder base (114) of the auxiliary damper (110). In this exemplary embodiment, the cylinder base (114) forms the stop wall (57). The idle stroke is consumed.

During further closing of the device lid (12), the base tube (71) is retracted further into the outer tube (51). In the telescopic tube assembly (40), both dampers are retracted either sequentially or simultaneously. The retraction movement is decelerated by the two compression dampers, such that the device lid (12) lowers slowly onto the device lower part (11). With the device lid (12) closed, the telescopic tube assembly (40) has, for example, reached the end position (43) shown in FIG. 10.

In the telescopic tube assembly shown in FIGS. 9-13 as well, the total stroke, the idle stroke, and/or the damping stroke may be adjustable.

In the telescopic tube assembly (40), the damper piston (88) may be displaceably mounted in the outer tube (51). The piston rod (86) then projects into an idle stroke space (61) arranged in the base tube (71). In this exemplary embodiment, an auxiliary damper (110) may be mounted in the base tube (71) having the idle stroke space (61).

It is conceivable to combine the individual exemplary embodiments with one another.

### LIST OF REFERENCE SIGNS

10 device
11 device lower part
12 device lid
13 pivot joints
14 center of mass
15 pivot axis
16 operating position
17 mounting point on the device lower part side
18 mounting point on the device lid side
19 cable eye
21 open position of (10, 12)
30 damper assembly
31 tension cable
32 thimble
33 thimble
40 telescopic tube assembly
41 start position
42 working stroke direction
43 end position
45 longitudinal direction of (40)
51 outer tube
52 base
53 cable eye
54 outer tube section
55 connection insert
56 receiving cup
57 stop wall
58 transverse slot
59 assembly opening
61 idle stroke space
62 annular sliding element
63 damper sleeve
64 gap seal
71 base tube
72 base tube section
73 guide section
74 compensation insert
75 closure plug
76 through bore
77 insert tube
78 compensation piston
79 compensation piston seal
81 compensation spring
82 cylinder head insert
83 outer surface
84 longitudinal passage in (82)
85 sealing ring
86 piston rod
87 retaining ring
88 damper piston
89 annular disk
91 throttle bores
92 valve disk
93 interior space of (71)
94 displacement space
95 compensation space
96 piston rod head
97 piston pin
98 base tube base
99 return spring
101 cable eye
110 auxiliary damper
111 auxiliary damping cylinder
112 auxiliary damping piston
113 auxiliary piston rod
114 cylinder base
115 auxiliary cylinder head
116 cylinder head seal
118 valve disk
119 auxiliary return spring

What is claimed is:

1. A telescopic tube assembly (40), comprising:
an outer tube (51); and
a base tube (71) guided in the outer tube (51) so as to be displaceable in a longitudinal direction (45) from a start position (41) in a working stroke direction (42) into an end position (43) and back; and
a damper piston (88) connected to a piston rod (86) displaceably mounted in the base tube (71) or in the outer tube (51),
wherein the piston rod (86) projects into an idle stroke space (61) delimited by at least one stop wall (57),
wherein the idle stroke space (61) is arranged in the outer tube (51) or the base tube (71) that does not accommodate the damper piston (88),
wherein, in the start position (41), the piston rod (86) is spaced apart from the stop wall (57),
wherein, in the end position (43), the piston rod (86) bears against the stop wall (57), and
wherein, during a displacement movement of the outer tube (51) and the base tube (71) relative to one another from the start position (41) in the working stroke direction (42), the piston rod (86) strikes against the stop wall (57), and,
wherein upon continuation of the displacement movement directed in the working stroke direction (42), the piston rod (86) displaces the damper piston (88) relative to the base tube (71) or the outer tube (51) that accommodates the damper piston (88) while the damper piston (88) dampens the displacement movement.

2. The telescopic tube assembly (40) of claim 1,
further comprising an auxiliary damper (110) mounted in the outer tube (51) or the base tube (71) having the idle stroke space (61), the auxiliary damper (110) comprising a cylinder base (114) forming the stop wall (57).

3. The telescopic tube assembly (40) of claim 2,
wherein an auxiliary damping cylinder (111) of the auxiliary damper (110) is displaceably mounted in the longitudinal direction (45) in the outer tube (51) or in the base tube (71).

4. The telescopic tube assembly (40) of claim 2,
wherein a maximum stroke of the damper piston (88) is more than three times a maximum stroke of the auxiliary damper (110).

5. The telescopic tube assembly (40) of claim 1,
wherein a return spring (99) loading the damper piston (88) is arranged in the base tube (71).

6. The telescopic tube assembly (40) of claim 1,
wherein a utilized idle stroke is more than twice as large as a utilized damping stroke.

7. The telescopic tube assembly (40) of claim 1,
wherein a compensation space (95) with a spring-loaded compensation piston (78) is formed in the base tube (71).

8. The telescopic tube assembly (40) of claim 1,
wherein the base tube (71) is sealed against the outer tube (51) by a gap seal (64).

9. The telescopic tube assembly (40) of claim 1,
wherein, during movement of the base tube (71) and the outer tube (51) relative to one another in the working stroke direction (42), a length of the telescopic tube assembly (40) is increased.

10. The telescopic tube assembly (40) of claim 1,
wherein, during movement of the base tube (71) and the outer tube (51) relative to one another in the working stroke direction (42), a length of the telescopic tube assembly (40) is reduced.
